(19) United States
(12) Patent Application Publication
(10) Pub. No.: US 2007/0113472 A1
(43) Pub. Date: May 24, 2007

(54) AEROPONIC SYSTEM AND METHOD FOR PLANT PROPAGATION

(76) Inventor: Michael Plowman, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/555,843

(22) Filed: Nov. 2, 2006

Related U.S. Application Data
(60) Provisional application No. 60/732,812, filed on Nov. 2, 2005.

(51) Int. Cl. A01G 31/00

(52) U.S. Cl. 47/62 A

(57) ABSTRACT

An aeroponic system for propagating plants and/or seeds includes a chamber, a cooling system and a liquid delivery system. The cooling system is coupled to the chamber which includes a top portion for supporting plants and/or seeds. The top portion may include orifices to which holders may be connected. The holders can be configured to support a plant so that the roots of the plant are located within the chamber and the remainder of the plant is located outside the chamber. In addition, the chamber contains a liquid, which may include a nutrient solution. The liquid is delivered to the plants and/or seeds by the liquid delivery system and maintained within a liquid temperature range by the cooling system. The system may be adapted to propagate different types of seeds and plants.

### CROSS REFERENCE TO RELATED APPLICATION

This application claims priority to U.S. Provisional Patent Application No. 60/732,812, filed Nov. 2, 2005, the contents of which are hereby incorporated by reference.

### BACKGROUND

Growing and sustaining plants aeroponically involves supplying a nutrient solution to the roots of the plants, such as by spraying. The solution may include water, fertilizers and other nutrients. Optimal growth and the survival of the plants require that the roots of the plants be kept within a particular temperature range. This temperature range may be lower than is required for the portion of the plant above the roots. This parallels the situation in nature in which the stem and leaves of the plant are exposed to the air, and the roots of the plant are located in the ground, which is generally at lower temperature than the air.

Thus, some aeroponic growing devices include some type of refrigeration to cool the nutrient solution before it is supplied to the roots of the plants. The refrigeration for these aeroponic devices is not located with the reservoir that holds the solution, but is located remotely from the other portions of the growing device. In addition, many of these devices constantly spray solution onto the roots of the plants, leading to root destruction from causes such as root-rot.

### SUMMARY

An aeroponic system for propagating plants and/or seeds includes a chamber, cooling system and a nutrient delivery system. The cooling system is coupled to the chamber directly or indirectly. The chamber includes a top portion for supporting plants and/or seeds. For example, the top portion may include orifices onto which holders may be connected. A holder generally supports a plant so that the roots of the plant are located within the chamber and the remainder of the plant is located outside the chamber. In addition, the chamber holds a nutrient solution, which is delivered to the plants and/or seeds by the nutrient delivery system and maintained within a predetermined temperature range by the cooling system. The system may be adapted to propagate various types of seeds and plants.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an isometric view of an aeroponic system.

FIG. 2 is a cross-sectional view of the aeroponic system of FIG. 1 viewed along line A-A.

FIG. 3 is an expanded cross-sectional view of a portion of the aeroponic system of FIG. 2.

FIG. 4 is a cross-sectional view of an aeroponic system.

FIG. 5 is a cross-sectional view of an aeroponic system.

FIG. 6 is a top view of the aeroponic system of FIG. 5 with the top portion removed.

### DETAILED DESCRIPTION

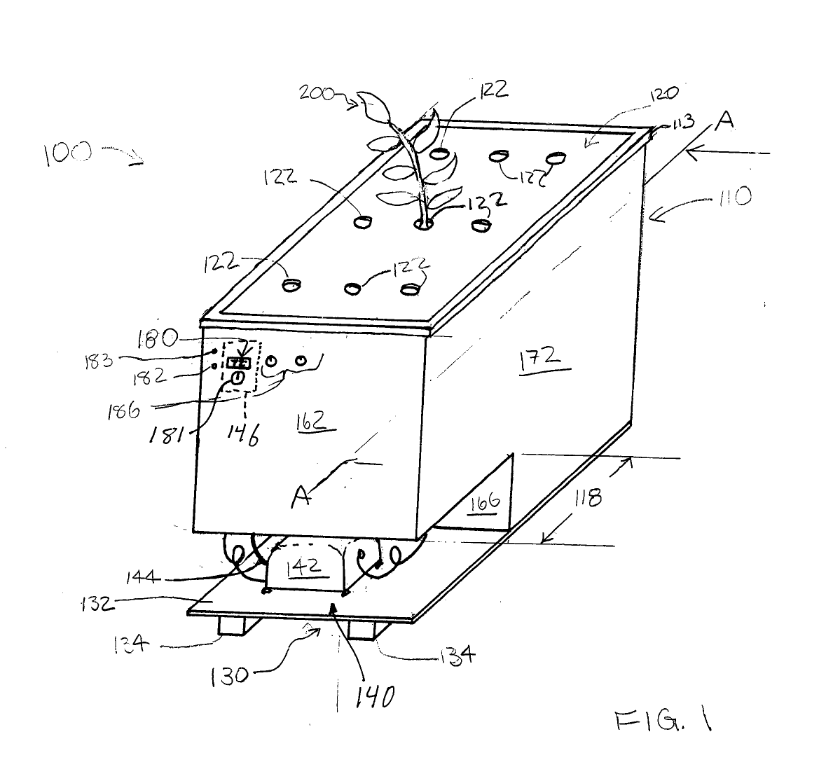

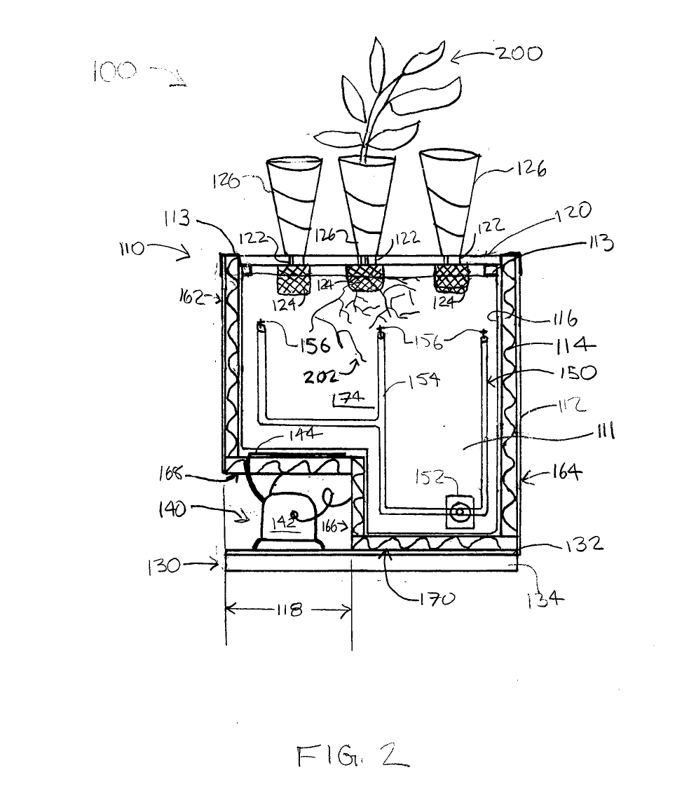

FIGS. 1 and 2 illustrate an example of an aeroponic system (also referred to as “the system” or “this system”) 100. The system 100 generally includes a chamber 110, a cooling assembly 140, and a nutrient delivery system 150. The system 100 may accommodate a number of plants 200 or seeds (not shown). Although only one plant 200 is shown in FIGS. 1 and 2, the system 100 may be designed to accommodate any number, type and combination of plants and seeds. The descriptions that follow apply to any such design.

The chamber 110 supports the plant 200 and holds a liquid that is supplied to the plants. In some constructions, the liquid is a nutrient solution designed specifically for the nutritional needs of the plants. The composition of the nutrient solution may vary with the particular needs of the type of plant supported by the system 100. The cooling assembly 140 cools the solution to a solution temperature within a solution temperature range, and the nutrient delivery system 150 delivers the nutrient solution to the roots of the plant 200, or to a seed (not shown).

The cooling assembly 140 may be coupled to the chamber 110, either directly or indirectly, so that the cooling assembly 140 and the chamber 110 may be moved together, thus making the system 100 portable. The system 100 may also include a support 130 to which the chamber 110 and the cooling assembly 140 may be coupled. The support 130 may include a plate 132 to which the chamber 110 and the compressor 142 may be coupled using screws, bolts and/or the like. In this manner the support 130 provides a structure that indirectly couples the cooling assembly 140 to the chamber 110. The support 130 may also include one or more legs 134 located under the plate 132 that maintains the plate 132 above the surface on which the system 100 rests. This facilitates easier lifting of the system 100 by allowing the underside of the plate 132 to be engaged. The support 130, including the plate 132 and the legs 134, may include any type of suitable material such as metal or wood. For example, the materials used for the plate 132 and/or the legs may include aluminum.

The chamber 110 generally includes one or more walls 162, 164, 166, 168, 170, 172, and 174, and a top portion 120 that define a reservoir 111 within. The chamber 110 of FIGS. 1 and 2 includes a generally rectangular shape. However, the chamber 110 may include any shape. The chamber 110 may also include an overhanging portion 118, under which the cooling assembly 140 may be located. Such an arrangement reduces the footprint of the system 100.

The top portion 120 provides support for one or more plants and/or seeds. The top portion 120 may include a plurality of orifices 122 so that plants, such as plant 200, may be positioned so that their roots 202 are located within the chamber 110 and their remaining parts (such as the stem, leaves, flowers, and/or vegetables) are located outside the chamber 110. The top portion may include a plastic material such as high density polyethylene (HDPE).

The top portion 120 may be adapted to support different types of plants. The distance between the orifices may be selected to provide sufficient room for a particular type of plant to propagate while supporting as many plants as possible.

In addition, the top portion 120 may include a holder for supporting a plant or seed. The holder may include a lower holder 124. This lower holder 124 may support one or more seeds and/or the roots 202 of a plant 200 inside the chamber 110, and may include holes, a mesh, a basket or the like that allow the roots 202 to extend into the reservoir 111 as the roots 202 grow. The lower holder 124 may hold rock wool or other material or materials in which a seed can germinate. In another example, the holder may include an upper holder 126 that provides support to the upper portion of the plant 200 outside the chamber 110. The upper holder 126 may include a cone shape, as shown in FIG. 2, but may include other shapes as well. The upper holder 126 may include holes, mesh or other structure through which the leaves and/or other portions of the plant may extend as the plant grows.

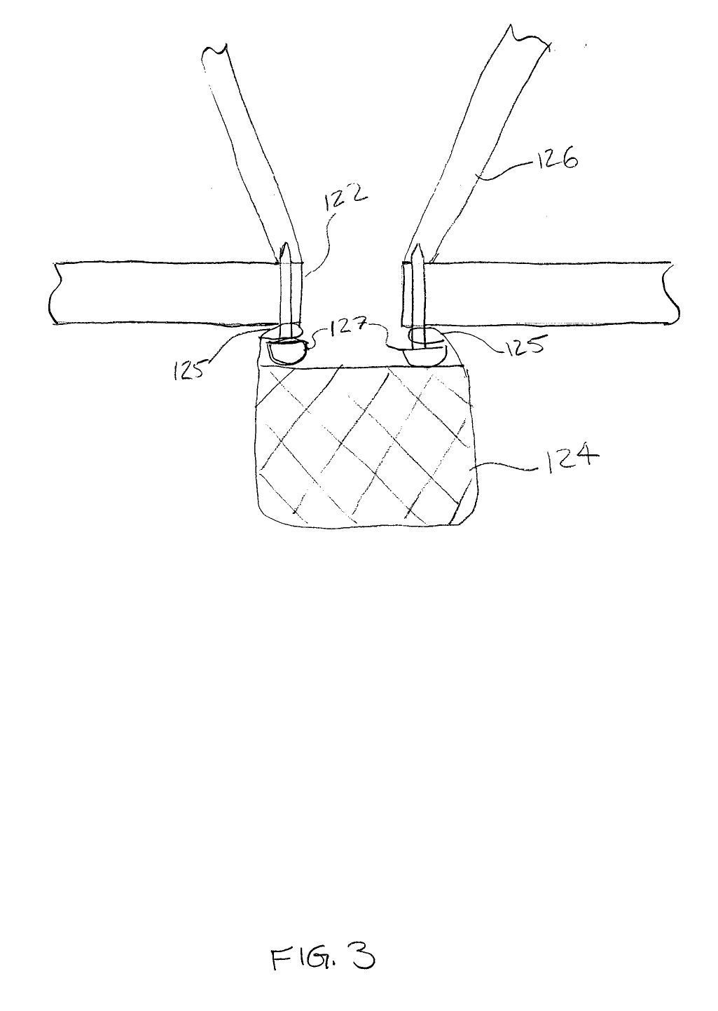

An example of a manner in which an upper holder 126 and a lower holder 124 may be attached to the top portion 120 is shown in FIG. 3. In this example, the upper holder 126 and the lower holder 124 are attached to the top portion 120 by fasteners 127. To couple the upper holder 126 to the top portion 120, the fasteners 127 may be inserted from underneath the top portion 120, through the top portion 120 and into the upper holder 126. To couple the lower holder 124 to the top portion 120, loops 125 may be coupled to the lower holder 124 and arranged around the fasteners 127. Alternately, the loops 125 may be an extension of the lower holder 124. For example, if the lower holder 124 includes a wire mesh, wire from the mesh may be used to form the loops 125. The loops 125 may be arranged around the fasteners 127 before or after the fasteners 127 are inserted through the top portion 120. In another example, the fasteners 127 may be inserted from above the top portion 120, through the inner wall of the upper holder 126 and through the top portion 120. To couple the lower holder to the top portion 120, nuts and/or washers (not shown) may be coupled to the fasteners 127 from underneath the top portion 120. The upper and lower holders 126, 124 may be coupled to the top portion 120 using other configurations as well, including without limitation clamps, clips, adhesives, welding, and the like.

The top portion 120 may include the lower and/or upper holders 124, 126 or may not contain any holder. For example, if tomato plants are to be propagated, the top portion 120 may include the lower and upper holders 124, 126. In another example, if lettuce is to be propagated, the top portion 120 may not include any holder. Further, the system 100 may include multiple top portions 120, each adapted to accommodate a different type of plant or seed. For example, a first top portion 120 may be provided with orifices 122 spaced apart from one another by a first distance suitable for propagating a certain type of plant. A second top portion 120 may also be provided with orifices 122 spaced apart from one another by a second distance, different than the first distance, for propagating a different type of plant. In this manner, the system 100 may be converted from a configuration adapted for the propagation of one type of plant to a configuration adapted for the propagation of a different type of plant by replacing one top portion 120 with another. Similarly, a single top portion 120 may be provided with two or more groups of orifices 122, each orifice in a given group spaced apart from the other orifices in the group by a distance suitable for propagating a specific type of plant. In this regard, two or more different types of plants may be propagated using the same top portion 120. In some constructions, the top portion 120 may include a lightweight material, such as plastic, which may add to the ease of such replacement.

Referring to FIG. 2, the top portion 120 may be supported by the top of one or more of the walls 162, 164, 172, 174, or by an edge 113 located near the top of one or more of the walls, depending on the shape of the chamber 110. The edge 113 may run continuously along the approximate top of some or all of the vertical walls 162, 164, 172 and 174 or be positioned in discrete locations. The edge 113 may include a material such as steel, stainless steel or sheet metal. For example, the edge 113 may include a food-safe material, such as stainless steel. In some constructions the walls 162, 164, 172, 174 include an insulating layer 114 that may include a rigid insulation board, such as extruded polystyrene, or other suitable insulating material. Furthermore, the outer surface of some of the walls, may include a weather-resistant covering, such as sheet metal. To reduce radiant heat absorption by the system 100 (e.g. from sunlight), the outer surfaces of the chamber may include or be painted or otherwise colored a light color, such as white. In some constructions, the reservoir 111 includes a lining 116. The lining 116 may include a water-tight material, such as PVC.

The cooling assembly 140 maintains the liquid stored in the reservoir 111 within a desired temperature range. In this regard, plant roots and seeds may be maintained at a temperature that is lower than the temperature at which the remainder of the plant is maintained. The specific temperature range at which the roots and seeds are maintained will depend, at least in part, upon the surrounding environment in which the system 100 is placed, and upon the type of plants and/or seeds that are being propagated. For example, to propagate lettuce, the desired temperature may be in the range of about 60 to about 80 degrees Fahrenheit, or, more preferably, in the range of about 64 to about 76 degrees Fahrenheit, or even more preferably, in the range of about 68 to about 72 degrees Fahrenheit.

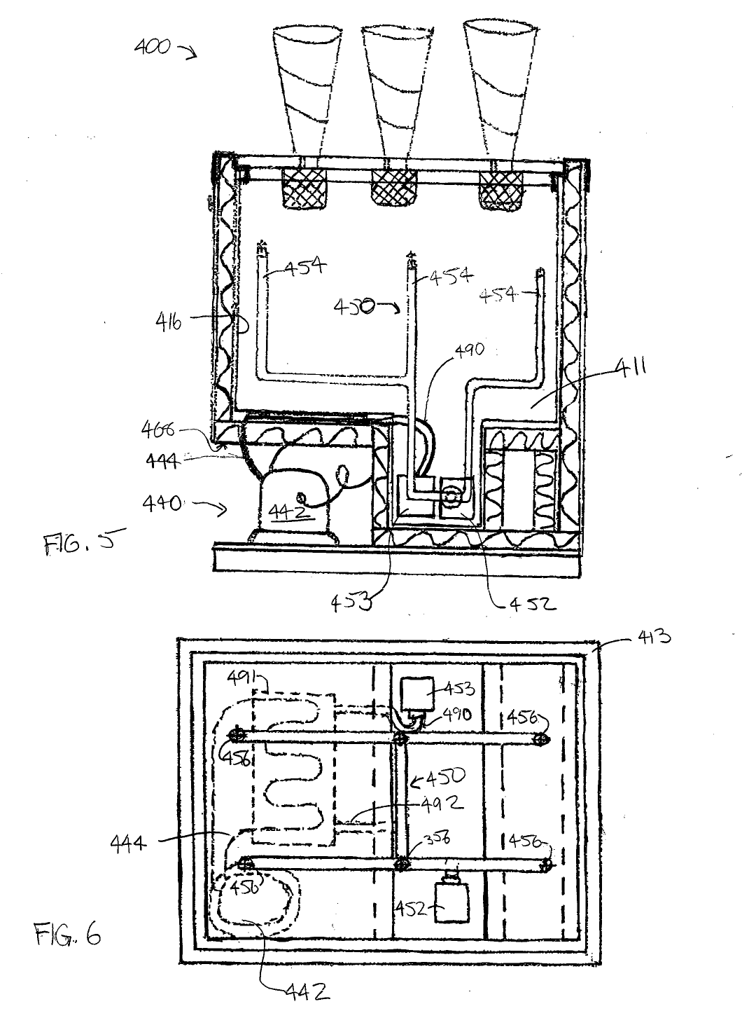

The cooling assembly 140 may include a compressor 142, evaporator line 144, and a thermostat 146. The evaporator line 144 may be positioned in the chamber 110. For example, as shown in FIG. 2, the evaporator line 144 goes thru a wall 168 in the chamber 110 and may be located between the insulating layer 114 of the wall 168 and the lining 116. The wall 168 may include an orifice (not shown) through which the evaporator line 144 enters the chamber 110. To cool the liquid in the reservoir 111, as well as the reservoir 111 itself, the compressor 142 compresses a coolant, such as those used in refrigeration, and supplies the compressed coolant to the reservoir 111 via the evaporator line 144. The compressed coolant removes the heat from the reservoir 111, and returns to the compressor 142. To provide more efficient and/or effective heat removal, the cooling assembly 140 may further include a cooling plate 491 (see FIG. 6). The cooling plate 491 includes a thermally conductive material and is located between the insulating layer 114 of the wall 168 and the lining 116. The evaporator line 144 runs through the cooling plate 491, thereby cooling the cooling plate 491. The cooling plate 491 increases the amount of surface area available to remove heat from reservoir 111 and the liquid. To obtain or maintain the liquid within a desired temperature range, the thermostat 146 regulates operation of the evaporator 142. For example, the thermostat 146 may include or be in communication with a temperature sensor (not shown), which measures the temperature of at least one of the reservoir 111 and the liquid held by the reservoir 111. The temperature, as measured by the temperature sensor, is monitored by the thermostat 146 so that when the temperature reaches or rises above a maximum temperature, the thermostat 146 turns on the compressor 142. Similarly, when the temperature reaches or falls below a minimum temperature, the thermostat 146 turns off the compressor 142. The thermostat 146 may include a gauge 180 (FIG. 1) that displays the sensed temperature, and an adjustment device, such as a dial 181, for selecting a desired median solution temperature. It should be appreciated that the degree of variation of temperature (e.g. the temperature range between the maximum temperature and the minimum temperature) about the desired median solution temperature will depend upon, among other things, the accuracy and precision of the thermostat 146, the accuracy and precision of the temperature sensor, the rate at which the compressor 142 is able to respond to the on/off commands provided by the thermostat 146 to compress the coolant, and the efficiency with which heat is transferred from the liquid and/or the reservoir 111 to the coolant.

The nutrient solution may be delivered to the roots 202 by a nutrient delivery system 150. The nutrient delivery system 150 may include a pump 152, one or more pipes or tubes 154 and one or more sprinkler heads 156. The pump 152 may include a magnetic pump. The sprinkler heads 156 are coupled to the tubes 154, which may include, for example, one or more PVC pipes. During operation, the pump 152 pumps the nutrient solution from the reservoir 111 into the tubes 154. The pressure from the pump 152, causes the solution to flow through the tubes 154 to the sprinkler heads 156. The sprinkler heads 156 disperse or spray the nutrient solution into the reservoir 111 for delivery to the plant roots 202 or to seeds in the lower holders 124.

The system 100 may include one or more controls and/or displays. For example, the system 100 may include an indicator 182, such as a light, that indicates when the system 100 is receiving electrical power. The system 100 may include an indicator 183, in communication with a level sensor (not shown) in the reservoir 111 that indicates when the nutrient solution reaches a specific level. To control the delivery of the nutrient solution to the roots 202 and/or seeds, the system may include a timer 186. The timer 186 may be in electromagnetic communication with the pump 152 of the nutrient delivery system 150 via a wired or wireless communications. The timer 186 may turn on the pump 152 at predetermined intervals for a predetermined time period. The intervals and time period may be selected according to the type of plant or seed that is to be propagated in the system 100. For example, for propagating fully grown lettuce, the timer may turn on the pump 152 for about three minutes (the time period) every thirty minutes (the time interval). The timer 186 may include two separate controls 186 (as shown in FIG. 1), one for adjusting the “on” time period, and one for adjusting the time interval. Alternately, the timer 186 may include a single control by which the time period may be adjusted as a percentage of the time interval.

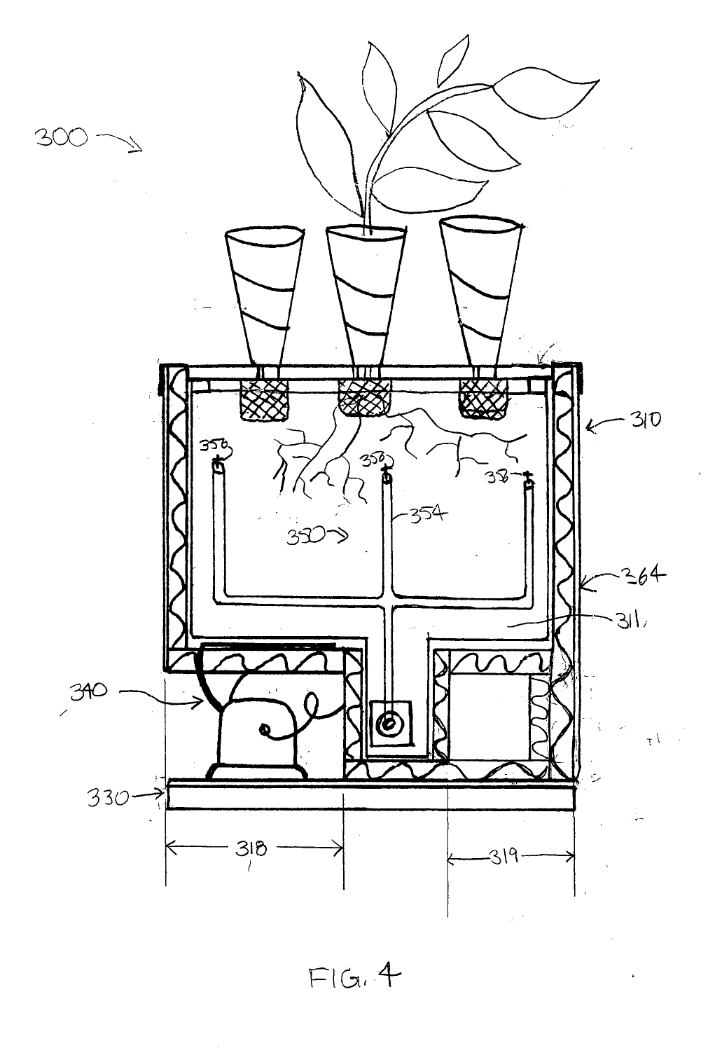

FIG. 4 illustrates another example of an aeroponic system or “system” 300. The description provided above in connection with the aeroponic system 100 shown in FIGS. 1 and 2 applies to the aeroponic system 300 of FIG. 4, except as described below. Components of the system 300 that are similar to components of the system 100 have been given the same reference numeral, increased by two-hundred. The system 300 shown in FIG. 4 is similar to the system 100 shown in FIGS. 1 and 2. However, in addition to overhang portion 318, the chamber 310 shown in FIG. 4 includes a second overhang portion 319. This second overhang portion 319 reduces the size of the reservoir 311, and thus the amount of nutrient solution that may be stored in the reservoir 311. Because the amount of nutrient solution stored in the reservoir 311 is reduced, the energy needed by the cooling assembly 340 to cool the nutrient solution is also reduced. For example, the second overhang portion 319 may include dimensions that reduce the capacity of the reservoir 311 by 30-40 gallons. Wall 364, which may extend to the support 330, provides stability for the system 300. Further, alternate or additional walls may also extend to the support 330, so that, for example, the system 300 appears virtually identical to the system 100 of FIG. 1 from the outside. As shown in FIG. 4, the tubes or pipes 354 may include a different arrangement than that of the tubes or pipes 154 shown in FIG. 1 to accommodate the second overhang portion 319.

FIGS. 5 and 6 illustrate another example of an aeroponic system or “system” 400. The description provided above in connection with the aeroponic system 300 shown in FIG. 4 applies to the aeroponic system 400 of FIGS. 5 and 6, except as described below. Components of the system 400 that are similar to components of the system 100 have been given the same reference numeral, increased by three-hundred. In addition to the first pump 452, which moves the nutrient solution from the reservoir 411 into the tubes 454, the system 400 includes a second pump 453. The second pump 453, which may include a magnetic pump, moves the nutrient solution over the cooling plate 491 to provide more effective and/or efficient control of the temperature of the solution. As previously discussed, the evaporator line 444 runs through the cooling plate 491, both of which are generally located between the insulation board of wall 468 and the liner 416. The temperature of the nutrient solution may be controlled by a thermostat and a probe in, for example, the manner previously discussed. In addition, to more quickly cool the nutrient solution, the second pump 453 circulates the nutrient solution over the cooling plate 491. The second pump 453 may run continuously or be switched on and off approximately simultaneously with the condenser 442.

The second pump 453 moves the nutrient solution from the reservoir 411, past the cooling plate 491 and back into the reservoir 411 via a tube 490. The tube 490 goes through the liner 416 so that it comes into contact with the cooling plate 491. To prevent nutrient solution from leaking between the liner 416 and the walls of the system 400, the liner 416 may be sealed around the tube 490. To provide this seal, a hole having a diameter smaller than that of the tube 490 may be made in the liner 416. Thus, when tube 490 is inserted into the hole, the liner 416 may stretch to accommodate and provide a seal around the tube 490. Various types of liquid or gel-type sealants may also be used. For example, if the liner 416 and the tube 490 include PVC material, a solution, such as PVC welding solution may be used to weld the liner 416 to the tube 490. The PVC welding solution, which generally includes PVC in a solvent, may be applied around the intersections of the liner 416 and the tube 490. The solution may also be applied to the surface of the liner 416 that will ultimately face the walls of the system 400.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An aeroponic system for propagating a seed and/or a plant, the system comprising:
a chamber that receives the seed and/or a root of the plant and contains a liquid;
a cooling assembly coupled with the chamber and configured to cool at least one of the liquid and the chamber; and
a liquid delivery system configured to deliver the liquid to the seed and/or root.

2. The system of claim 1, wherein the chamber includes a top portion defining an orifice through which a portion of the plant may extend from the chamber.

3. The system of claim 2, wherein the chamber further includes a holder coupled to the top portion to support the plant and/or seed.

4. The system of claim 3, wherein the holder includes a lower holder to support the root and/or seed inside the chamber.

5. The system of claim 3, wherein the holder includes an upper holder to support the plant outside the chamber.

6. The system of claim 1, wherein the chamber includes a first top portion defining a plurality of first orifices each spaced apart by a first distance, and a second top portion defining a plurality of second orifices each spaced apart by a second distance, and wherein the first and second top portions are interchangeable for propagation of different types of plants and/or seeds.

7. The system of claim 1, wherein the chamber includes a first overhang portion.

8. The system of claim 7, wherein the cooling assembly includes a compressor located under the first overhang portion.

9. The system of claim 7, wherein the chamber includes a second overhang portion, the second overhang portion cooperating with the first overhang portion to reduce a volume of the chamber.

10. The system of claim 1, wherein the cooling assembly includes an evaporator line that extends at least partially into the chamber to cool at least one of the liquid and the chamber.

11. The system of claim 10, wherein the cooling assembly includes a cooling plate through which the evaporator line extends, the system further comprising a pump that pumps the liquid to the cooling plate.

12. The system of claim 1, wherein the liquid is a nutrient solution.

13. The system of claim 1, wherein the liquid delivery system is configured to periodically deliver the liquid to the seed and/or root.

14. The system of claim 13, further comprising a timer communicating with the liquid delivery system to regulate the periodic delivery of the liquid to the seed and/or root.

15. The system of claim 1, further comprising a temperature sensor that senses a temperature of the liquid, and a thermostat communicating with the temperature sensor and the cooling assembly, wherein the thermostat is operable to regulate operation of the cooling assembly to maintain the temperature of the liquid within a liquid temperature range.

16. The system of claim 1, wherein at least a portion of the liquid delivery system is positioned within the chamber.

17. The system of claim 1, wherein the chamber includes a top portion having a first set of orifices and a second set of orifices, and wherein each orifice of the first set is spaced from an adjacent orifice of the first set by a first distance suitable for propagation of a first type of plant, and each orifice of the second set is spaced from an adjacent orifice of the second set by a second distance suitable for propagation of a second type of plant.

18. A method for aeroponically propagating a plant and/or seed, the method comprising:
providing a chamber including a top portion defining at least one orifice through which a portion of the plant may extend;
disposing the seed and/or a root of the plant within the chamber;
providing a liquid within the chamber;
cooling at least one of the liquid and the chamber with a cooling assembly;
providing a liquid delivery system; and
delivering the liquid to the root and/or seed with the liquid delivery system.

19. The method of claim 18, further comprising sensing a temperature of the liquid and maintaining the temperature of the liquid within a liquid temperature range, wherein maintaining the temperature of the liquid within a liquid temperature range includes controlling operation of the cooling assembly in response to the sensed temperature of the liquid.

20. The method of claim 18, wherein delivering the liquid to the root and/or seed with the delivery system includes periodically delivering the liquid to the root and/or seed with the delivery system.

21. The method of claim 20, further comprising providing a timer in communication with the delivery system, and setting the timer to regulate the periodic delivery of the liquid to the root and/or seed with the delivery system.

22. The method of claim 18, further comprising positioning the cooling assembly beneath an overhang defined by the chamber.

23. The method of claim 18, further comprising supporting the plant and/or seed with a holder coupled to the top portion.

24. The method of claim 23, wherein supporting the plant and/or seed includes at least one of:
positioning a lower holder within the chamber and supporting the root or seed with the lower holder; and
positioning an upper holder above the orifice and supporting the plant outside the chamber.

25. The method of claim 18, wherein providing a liquid delivery system includes positioning at least a portion of the liquid delivery system within the chamber.
